(19) United States
(12) Patent Application Publication
(10) Pub. No.: US 2025/0372599 A1
(43) Pub. Date: Dec. 4, 2025

(54) ELECTRODE SHEET MANUFACTURING DEVICE

(71) Applicants: Prime Planet Energy & Solutions, Inc., Tokyo (JP); JTEKT CORPORATION, Aichi-ken (JP)

(72) Inventors: Yuuki TOYOSHIMA, Himeji-shi (JP); Hiroyoshi YAMAMOTO, Himeji-shi (JP); Joji SHITARA, Himeji-shi (JP); Yukihiro TANAKAMARU, Himeji-shi (JP); Tetsuya SATO, Kobe-shi (JP); Hideki NAGANO, Nagoya-shi (JP); Ikuo CHIDAI, Kariya-shi (JP)

(21) Appl. No.: 19/209,819

(22) Filed: May 16, 2025

(30) Foreign Application Priority Data
May 28, 2024 (JP) 2024-086697

(51) Int. Cl. H01M 4/04

(52) U.S. Cl. CPC H01M 4/0435

(57) ABSTRACT

An electrode sheet manufacturing device is a device for manufacturing an electrode sheet including a non-formed portion and an active material layer, and includes: a conveyor that conveys the electrode sheet; a support roll that supports the electrode sheet; a pressing roll including a rubber layer at a surface thereof and facing the support roll; and a driver that presses pressing roll against the support roll. The pressing roll sandwiches the non-formed portion together with the support roll. The electrode sheet manufacturing device stores a predetermined relationship between a conveyance speed of the electrode sheet and a pressing force of the driver, and controls the pressing force of the driver based on the conveyance speed of the electrode sheet and the stored relationship.

### CROSS REFERENCE TO RELATED APPLICATIONS

This application claims the benefit of priority to Japanese Patent Application No. 2024-086697 filed on May 28, 2024. The entire contents of this application are hereby incorporated herein by reference.

### BACKGROUND

The present disclosure relates to an electrode sheet manufacturing device.

Japanese Patent Application Publication No. 2023-36089 discloses a method for manufacturing an electrode. In this method, in a precursor sheet (i.e., electrode sheet) including metal foil, a coated portion coated with an electrode material on the metal foil, and an uncoated portion not coated with the electrode material on the metal foil, the uncoated portion is pressed by a pair of elastic rolls (rubber rolls). The coated portion and the uncoated portion are individually pressed to adjust an elongation difference. When the uncoated portion is pressed with rolls other than elastic rolls, a tensile force causes voids inside the uncoated portion. These voids might cause breakage of the uncoated portion. By pressing the uncoated portion with the pair of elastic rolls, a compressive force and a deformation force can be applied to the same portion of the uncoated portion. This compressive force is caused by deformation of the elastic rolls due to contact with the pair of elastic rolls. Accordingly, the uncoated portion can be extended with breakage of the uncoated portion suppressed.

### SUMMARY

Inventors of the present invention found that in the manufacturing method of the patent document described above, when the conveyance speed of the electrode sheet changes, the elongation amount of the non-formed portion (uncoated portion) changes.

An electrode sheet manufacturing device disclosed here is a manufacturing device for manufacturing an electrode sheet including a current collector of long metal foil, a non-formed portion defined along a length direction at a predetermined position in a width direction in the current collector, and an active material layer located in a portion of the current collector except for the non-formed portion, and the electrode sheet manufacturing device includes: a conveyor that conveys the electrode sheet along a predetermined conveyance path; a support roll that is located on the conveyance path, extends in a width direction of the electrode sheet, and supports a first surface of the electrode sheet conveyed along the conveyance path; a pressing roll including a rubber layer at a surface thereof, located toward a second surface of the electrode sheet to face the support roll, and extending in the width direction of the electrode sheet; a driver that drives at least one of the support roll and the pressing roll such that the pressing roll is pressed against the support roll; and a controller. The pressing roll sandwiches the non-formed portion together with the support roll except for the active material layer of the electrode sheet. The controller includes a memory that stores a predetermined relationship between a conveyance speed of the electrode sheet by the conveyor and a pressing force of the driver, and a pressure controller that controls the pressing force of the driver based on the conveyance speed of the electrode sheet and the relationship stored in the memory.

In the electrode sheet manufacturing device, a pressing force is controlled based on the predetermined relationship between the conveyance speed of the electrode sheet and the pressing force of pressing the non-formed portion so that a change of the elongation amount of the non-formed portion can be suppressed even with a change of the conveyance speed of the electrode sheet.

### BRIEF DESCRIPTION OF THE DRAWINGS

FIG. 1 is a flowchart of manufacturing of an electrode sheet 10.

FIG. 2 is a schematic view of the electrode sheet 10.

FIG. 3 is a schematic side view of an electrode sheet manufacturing device 1.

FIG. 4 is a front view of a roll pressing machine 60.

FIG. 5 is a cross-sectional view taken along line A-A in

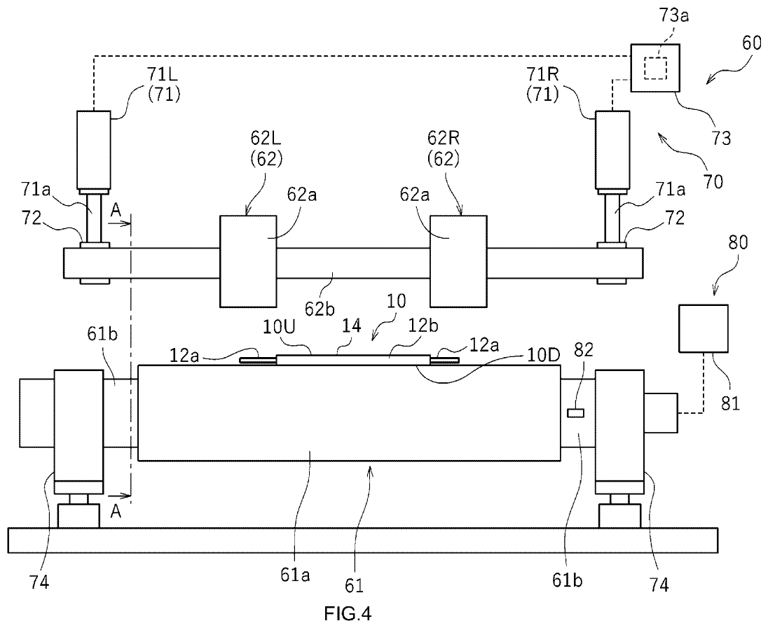

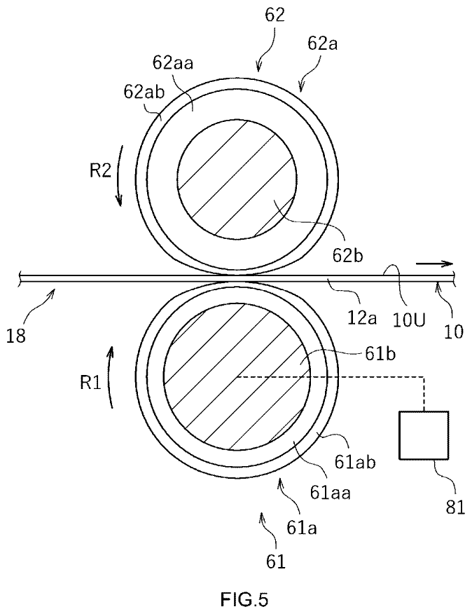

FIG. 4.

FIG. 6 is a graph showing a relationship between a conveyance speed of the electrode sheet 10 and a pressing force of a cylinder driving device 73.

FIG. 7 is a graph showing a relationship between the conveyance speed of the electrode sheet 10 and an elongation amount of an uncoated portions 12a.

### DETAILED DESCRIPTION

A preferred embodiment of the technique disclosed here will be described hereinafter with reference to the drawings. The preferred embodiment described herein is, of course, not intended to particularly limit the present invention. Each drawing is a schematic view and does not necessarily reflect an actual product. Members and parts having the same functions are denoted by the same reference numerals as appropriate, and description for the same members and parts will not be repeated as appropriate.

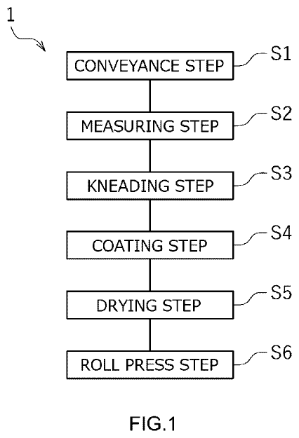

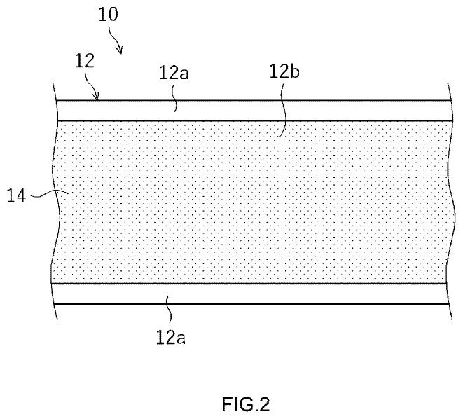

FIG. 1 is a flowchart of manufacturing of an electrode sheet 10 (see FIG. 2) by an electrode sheet manufacturing device 1. As illustrated in FIG. 1, manufacturing of the electrode sheet 10 in the electrode sheet manufacturing device 1 includes conveyance step S1, measuring step S2, kneading step S3, coating step S4, drying step S5, and roll press step S6. The manufacturing of the electrode sheet 10 in the electrode sheet manufacturing device 1 may include other steps.

### <Electrode Sheet Manufacturing Device 1>

In the electrode manufacturing device 1, the electrode sheet 10 constituting a power storage device is manufactured. The electrode sheet 10 constitutes a positive electrode sheet or a negative electrode sheet of an electrode body housed inside the power storage device. The power storage device refers to a device enabling repetitive charging and discharging, and generally includes so-called storage batteries (i.e., chemical batteries) such as a lithium ion secondary battery, a nickel hydrogen battery, and a nickel-cadmium battery and capacitors (i.e., physical batteries) such as an electric double layer capacitor. Hereinafter, as an example, the electrode sheet manufacturing device 1 that manufactures an electrode sheet 10 will be described together with a configuration of the electrode sheet 10 for use in lithium ion secondary batteries.

### <Electrode Sheet 10>

FIG. 2 is a schematic view of the electrode sheet 10. As illustrated in FIG. 2, the electrode sheet 10 includes a current collector 12 and an electrode active material layer 14. The current collector 12 is a member of long metal foil. The current collector 12 is a band-shaped metal member. As the current collector 12, a metal material having required conductivity can be used. As positive electrode current collecting foil, aluminium or an aluminium alloy can be used, for example. As negative electrode current collecting foil, copper or a copper alloy can be used, for example. The electrode active material layer 14 is applied onto a predetermined portion of the current collector 12. The electrode active material layer 14 is formed on at least one surface of the band-shaped current collector 12. In this preferred embodiment, the electrode active material layer 14 is formed on each surface of the current collector 12. The electrode active material layer 14 contains an electrode active material. As a positive electrode active material, a lithium transition metal composite oxide can be used, for example. As a negative electrode active material, a carbon material, a silicon-based material, and a mixed oxide thereof can be used, for example. The electrode active material layer may include an additive other than the electrode active material layer, such as a binder or a conductive material.

The electrode sheet 10 is formed by applying electrode mixture slurry as the electrode active material layer 14 onto the current collector 12 and drying the slurry. The current collector 12 includes uncoated portions 12a and a coated portion 12b. The uncoated portions 12a are portions of the current collector 12 not coated with the electrode active material layer 14. The uncoated portions 12a are defined along the length direction at predetermined positions in the width direction in the current collector 12. In this preferred embodiment, the uncoated portions 12a are defined at both ends of the electrode sheet 10 in the width direction. The uncoated portions 12a are an example of a non-formed portion defined along the length direction at a predetermined position in the width direction in the current collector 12, as a portion where the electrode active material layer 14 is not formed. The electrode active material layer 14 is formed on a portion of the current collector 12 except for the uncoated portions 12a. The electrode active material layer 14 is formed by coating on a portion of the current collector 12 except for the uncoated portions 12a. The coated portion 12b is located between the uncoated portions 12a at both ends of the electrode sheet 10. The electrode mixture slurry is applied onto the coated portion 12b. In this manner, the electrode active material layer 14 is formed on the coated portion 12b of the current collector 12. That is, the electrode active material layer 14 is located between the uncoated portions 12a at both ends of the electrode sheet 10 in the width direction.

### <Conveyor 15>

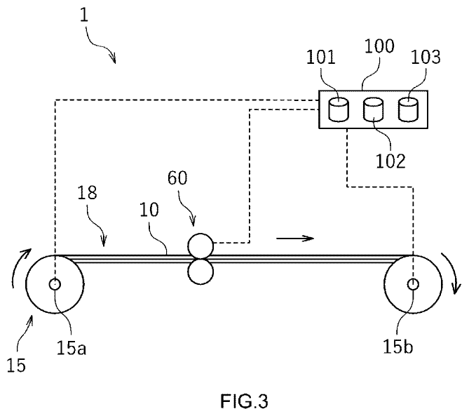

In conveyance step S1 shown in FIG. 1, the electrode sheet 10 is conveyed. FIG. 3 is a schematic side view of the electrode sheet manufacturing device 1. The conveyance step S1 can be implemented by the conveyor 15. The conveyor 15 conveys the long electrode sheet 10 along a predetermined conveyance path 18. The conveyor 15 employs, for example, a motor. As illustrated in FIG. 3, the conveyor 15 includes an unwinding roll 15a and a winding roll 15b. The unwinding roll 15a is located upstream of the roll pressing machine 60 in the conveyance direction. The winding roll 15b is located downstream of the roll pressing machine 60 in the conveyance direction. The conveyor 15 is not limited to the unwinding roll 15a and the winding roll 15b. For example, the conveyor 15 may include a roll other than the unwinding roll 15a and the winding roll 15b. In this preferred embodiment, the roll pressing machine 60 described later also includes a roll driving device 80 and a support roll 61 (see FIG. 4) that is rotated by the roll driving device 80, and the support roll 61 and the roll driving device 80 are also a part of the conveyor 15.

### <Measuring Step S2, Kneading Step S3, Coating Step S4, and Drying Step S5>

In measuring step S2 shown in FIG. 1, materials for the electrode active material layer 14 (see FIG. 2) are measured. The measurement can be performed using a measuring device (not shown) equipped with, for example, a balance or a load cell. The measured materials for the electrode active material layer 14 are mixed in kneading step S3. Kneading step S3 can be performed by a kneading device (not shown). A material for the electrode active material layer 14 made into slurry by the kneading device is applied onto the current collector 12 (see FIG. 2) by coating in coating step S4. Coating step S4 can be performed by, for example, a coating device (not shown) such as a slit coater, a gravure coater, a die coater, or a comma coater. In drying step S5, the applied slurry materials for the electrode active material layer 14 are dried. Drying step S5 can be performed by a drying device (not shown) that emits, for example, hot air or an infrared ray.

### <Roll Pressing Machine 60>

In roll press step S6, the electrode sheet 10 is pressed. Roll press step S6 can be performed by the roll pressing machine 60 shown in FIG. 3. As illustrated in FIG. 3, the electrode sheet 10 is pressed by the roll pressing machine 60 at some point in the conveyance path 18. The electrode sheet 10 is supplied by the unwinding roll 15a. The electrode sheet 10 pressed by the roll pressing machine 60: is wound by the winding roll 15b. The electrode sheet manufacturing device 1 includes a controller 100 that controls the unwinding roll 15a, the winding roll 15b, and the roll pressing machine 60.

FIG. 4 s a front view of the roll pressing machine 60. The roll pressing machine 60 according to this preferred embodiment presses the uncoated portions 12a of the electrode sheet 10 with rubber rolls before or after the electrode active material layer 14 is pressed. When the uncoated portions 12a are pressed by the rubber rolls, under a reaction force of elastic deformation and compressive deformation of the rubber rolls, the portion pressed by the rubber rolls are pressed and pulled. Consequently, the uncoated portions 12a can be extended with breakage of the uncoated portions 12a suppressed. For this function, the device that presses the uncoated portions 12a of the electrode sheet 10 with the rubber rolls can be referred to as an elasticity powered stretching (EPS) device. The electrode sheet manufacturing device 1 may include another device than the roll pressing machine 60 that presses the electrode active material layer 14s.

The roll pressing machine 60 includes the support roll 61, pressing rolls 62, a pressing force adjusting mechanism 70, and the roll driving device 80.

### <Support Roll 61>

The support roll 61 is located on the conveyance path 18 (see FIG. 3). The support roll 61 extends in the width direction of the electrode sheet 10. The support roll 61 supports a lower surface 10D of the electrode sheet 10 conveyed along the conveyance path 18, along the width direction of the electrode sheet 10. The lower surface 10D is an example of a first surface in the present invention. The support roll 61 is located below the pressing rolls 62. The support roll 61 is a rubber roll that presses the uncoated portions 12a of the electrode sheet 10, together with the pressing rolls 62. The support roll 61 includes a body 61a and both axial portions 61b.

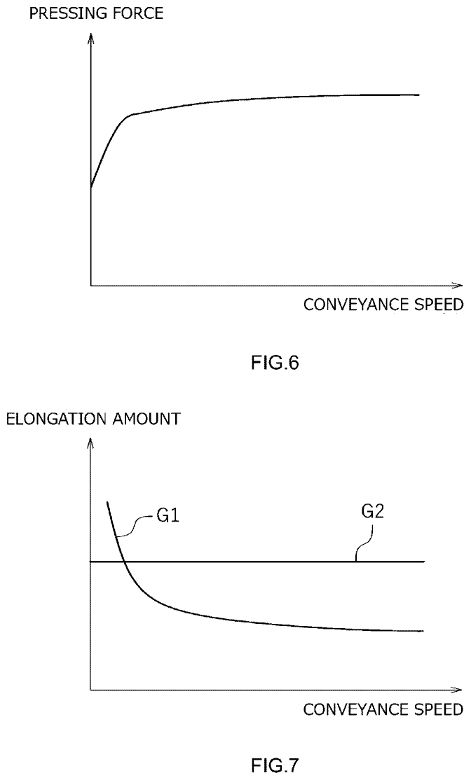

FIG. 5 is a cross-sectional view taken along line A-A in FIG. 4. Note that FIG. 5 illustrates a state where the uncoated portions 12a are pressed by the support roll 61 and the pressing rolls 62. As illustrated in FIG. 5, the body 61a includes an axis portion 61aa and a rubber portion 61ab. The axis portion 61aa is made of a metal. A material for the axis portion 61aa is not particularly limited, and is, for example, a material having a relatively high hardness such as SUS304 (stainless steel material). The rubber portion 61ab covers at least the outer circumference surface of the axis portion 61aa. A material for the rubber portion 61ab is, for example, nitrile rubber (NBR). The support roll 61 presses the uncoated portions 12a of the electrode sheet 10 with the rubber portion 61ab.

The support roll 61 rotates in a predetermined direction by the roll driving device 80 described later (see FIG. 4). In this preferred embodiment, the support roll 61 rotates in a direction of arrow R1 shown in FIG. 5. At this time, the electrode sheet 10 is conveyed from the left to the right when seen in the drawing. That is, in FIG. 5, the left is an upstream side in the conveyance direction, and the right is a downstream side in the conveyance direction.

As illustrated in FIG. 4, the both axial portions 61b are inserted in the body 61a. The both axial portions 61b are inserted in the axis portion 61aa (see FIG. 5) of the body 61a. The both axial portions 61b extend to the outside of the support roll 61 in the axial direction. Although not shown, a bearing and a gap screw that adjusts a gap between the support roll 61 and the pressing rolls 62, for example, are attached to the both axial portions 61b.

### <Pressing Rolls 62>

As illustrated in FIG. 5, the pressing rolls 62 are disposed to face the support roll 61 on an upper surface 10U of the electrode sheet 10. The pressing rolls 62 extend in the width direction of the electrode sheet 10. The pressing rolls 62 sandwich the uncoated portions 12a together with the support roll 61 except for the electrode active material layer 14 (see FIG. 2) of the electrode sheet 10. The upper surface 10U is an example of the second surface in the present invention. The positions of the axial centers of the pressing rolls 62 and the position of the axial center of the support roll 61 are aligned in the top-bottom direction. As illustrated in FIG. 4, the pressing rolls 62 are rubber rolls that press the uncoated portions 12a of the electrode sheet 10 together with the support roll 61. The pressing rolls 62 are not located above the electrode active material layer 14 of the electrode sheet 10. In this preferred embodiment, the uncoated portions 12a of the electrode sheet 10 are defined at both ends of the electrode sheet 10 in the width direction as described above. Thus, as illustrated in FIG. 4, the pressing rolls 62 are respectively located above the uncoated portions 12a at both ends of the electrode sheet 10 in the width direction. In the case where the number of the uncoated portions 12a is one, the number of the pressing rolls 62 may be one. In the two pressing rolls 62, the left pressing roll 62 will also be referred to as a pressing roll 62L, and the right pressing roll 62L will also be referred to as a pressing roll 62R. In the case where the description applies to both pressing rolls 62L and 62R, the term “pressing roll 62” will be used as appropriate. The pressing roll 62 includes a body 62a and a both axial portion 62b.

The pressing roll 62 includes a rubber layer at the surface thereof. As illustrated in FIG. 5, the body 62a includes an axis portion 62aa and a rubber portion 62ab. The axis portion 62aa is made of a metal. A material for the axis portion 62aa is not particularly limited, and is, for example, a material having a relatively high hardness such as SUS304 (stainless steel material). The rubber portion 62ab covers at least the outer circumference surface of the axis portion 62aa. A material for the rubber portion 62ab is not particularly limited and is, for example, nitrile rubber (NBR). The pressing roll 62 presses the uncoated portion 12a of the electrode sheet 10 with the rubber portion 62ab.

As illustrated in FIG. 4, the both axial portion 62b is inserted in the body 62a. The both axial portion 62b is inserted in the axis portion 62aa (see FIG. 5) of the body 62a. The both axial portion 62b extends to the outside of the two pressing rolls 62 in the axial direction. Although not shown, a bearing and a gap screw that adjusts a gap between the support roll 61 and the pressing rolls 62, for example, are attached to the both axial portion 62b.

As illustrated in FIG. 5, when the support roll 61 rotates in the direction of arrow R1 with the electrode sheet 10 sandwiched between the support roll 61 and the pressing rolls 62, the pressing rolls 62 are subjected to a force of rotation in the R2 direction of arrow through the electrode sheet 10. Alternatively, when the support roll 61 and the pressing rolls 62 are in contact with each other without the electrode sheet 10, the pressing rolls 62 are subjected to a force of rotation in the direction of arrow R2 by the rotation force of the support roll 61. Accordingly, the pressing rolls 62 rotate in the direction of arrow R2. That is, the pressing rolls 62 rotate in synchronization with rotation of the support roll 61.

### <Pressing Force Adjusting Mechanism 70>

As illustrated in FIG. 4, the pressing force adjusting mechanism 70 includes press cylinders 71, roll chocks 72, a cylinder driving device 73, and supporters 74.

The press cylinder 71 presses the pressing rolls 62 against the support roll 61. One press cylinder 71 is disposed on each outer side of one of both ends of the corresponding pressing roll 62. Here, the press cylinder 71 at the left of the electrode sheet 10 in FIG. 4 will also be referred to as a press cylinder 71L, and the press cylinder 71 at the right of the electrode sheet 10 will also be referred to as a press cylinder 71R. In description common to the press cylinders 71L and 71R, the term “press cylinder 71” will also be used. In this preferred embodiment, the press cylinders 71 are pneumatic cylinders. The press cylinders 71 include rods 71a. The rods 71a are connected to the roll chocks 72. The roll chocks 72 rotatably support the both axial portion 62b of the pressing rolls 62. When the press cylinders 71 are driven and the rods 71a move downward, the pressing rolls 62 move downward. When the press cylinders 71 are driven and the rods 71a move upward, the pressing rolls 62 move upward.

The cylinder driving device 73 presses the pressing rolls 62 against the support roll 61 with the electrode sheet 10 sandwiched between the pressing rolls 62 and the support roll 61. The cylinder driving device 73 is an example of a driver in the present invention. The driver drives at least one of the support roll 61 and the pressing rolls 62 to press the pressing rolls 62 against the support roll 61. In this preferred embodiment, the cylinder driving device 73 drives the pressing rolls 62. The driver may drive the support roll 61 or both the support roll 61 and the pressing rolls 62. The cylinder driving device 73 is connected to the press cylinders 71. The cylinder driving device 73 drives the press cylinders 71. In this manner, the rods 71a of the press cylinders 71 are moved upward and downward. In this preferred embodiment, the cylinder driver 73 is configured to drive the press cylinder 71L and the press cylinder 71R independently of each other. That is, the pressing rolls 62 located above the uncoated portions 12a at both ends of the electrode sheet 10 in the width direction are driven independently of each other. The cylinder driver 73 is connected to the controller 100 (see FIG. 3).

The cylinder driving device 73 can change a pressing force of the press cylinders 71 based on an input from the controller 100. The cylinder driving device 73 herein includes an electropneumatic regulator 73a. The electropneumatic regulator 73a controls an air pressure to be output in accordance with an input signal (e.g., input voltage or current). Typically, the electropneumatic regulator 73a outputs an air pressure in proportion to an input voltage. The cylinder driving device 73 is not limited to the device including the electropneumatic regulator 73a. The electropneumatic regulator 73a is not limited to the device designed for voltage control.

The supporters 74 support the support roll 61. The supporters 74 support the both axial portions 61b of the support roll 61.

### <Roll Driving Device 80>

The roll driving device 80 is connected to the support roll 61. The roll driving device 80 rotates the support roll 61. The roll driving device 80 and the support roll 61 are a part of the roll pressing machine 60 and also a part of the conveyor 15. In this preferred embodiment, the roll driver 80 rotates the support roll 61 in the direction of arrow R1 in FIG. 5. The roll driving device 80 is not limited to a specific configuration. In this preferred embodiment, the roll driving device 80 includes an electric motor 81. The electric motor 81 is connected to the controller 100 (see FIG. 3). The roll driving device 80 may rotate the pressing rolls 62.

The roll driving device 80 includes a speed sensor 82 that acquires a rotation speed of the support roll 61. The speed sensor 82 herein is an encoder that emits a pulse each time the support roll 61 rotates by a predetermined angle. The speed sensor 82 may be an encoder incorporated in the electric motor 81. Alternatively, the speed sensor 82 may be, for example, a sensor that directly measures a conveyance speed of the electrode sheet 10 from passage of a tab formed on the electrode sheet 10 or others. The speed sensor 82 is not particularly limited as long as the speed sensor 82 can measure the conveyance speed of the electrode sheet 10 directly or indirectly.

### <Controller 100>

As illustrated in FIG. 3, the controller 100 includes a speed acquirer 101, a pressure memory 102, and a pressure controller 103. The configuration of the controller 100 is not particularly limited. The controller 100 includes, for example, a microcomputer. The microcomputer may include, for example, an interface (I/F) that receives data or others from an external device, a central processing unit (CPU) that executes an instruction of a program, a read only memory (ROM) that stores a program to be executed by the CPU, a random access memory (RAM) that is used as a working area in which the program is developed, and a storage such as a memory that stores the program and various types of data.

The speed acquirer 101 acquires a conveyance speed of the electrode sheet 10 by the conveyor 15 (specifically the roll driving device 80) from the speed sensor 82.

The pressure memory 102 stores a predetermined relationship between the conveyance speed of the electrode sheet 10 by the conveyor 15 and a pressing force of the cylinder driving device 73. FIG. 6 is a graph showing a relationship between the conveyance speed of the electrode sheet 10 and the pressing force of the cylinder driving device 73. As shown in FIG. 6, in the relationship stored in the pressure memory 102, as the conveyance speed of the electrode sheet 10 increases, the pressing force of the cylinder driving device 73 is increased.

A graph G1 in FIG. 7 shows a relationship between the conveyance speed of the electrode sheet 10 and an elongation amount of the uncoated portions 12a of the electrode sheet 10 in a case where the pressing force of the cylinder driving device 73 is constant. As shown in the graph G1, according to findings of the inventors of the present invention, when the conveyance speed of the electrode sheet 10 is low, an elastic deformation time of the rubber portion 62ab of the pressing rolls 62 is long, and thus, the elongation amount of the uncoated portions 12a of the electrode sheet 10 is large. When the conveyance speed of the electrode sheet 10 is high, the elastic deformation time of the rubber portion 62ab of the pressing rolls 62 is short, and thus, with the same pressing force, the elongation amount of the uncoated portions 12a is small. In view of this, to keep the elongation amount of the uncoated portions 12a constant, the pressing force of the cylinder driving device 73 needs to be increased as the conveyance speed of the electrode sheet 10 increases. If the elongation amount of the uncoated portions 12a varies depending on the location, crease might occur in the uncoated portions 12a or the electrode sheet 10 might be broken.

The pressing force of the cylinder driving device 73 with respect to the conveyance speed of the electrode sheet 10 is set such that the elongation amount of the uncoated portions 12a is substantially the same regardless of the conveyance speed of the electrode sheet 10. The graph in FIG. 6 is obtained from an experiment conducted such that the elongation amount of the uncoated portions 12a of the electrode sheet 10 is set at a predetermined amount with respect to multiple conveyance speeds of the electrode sheet 10. FIG. 7 shows a graph G2 demonstrating a relationship between the conveyance speed of the electrode sheet 10 and the elongation amount of the uncoated portions 12a in the case of performing pressing force control shown in FIG. 6. As shown in the graph G2, when the pressing force control shown in FIG. 6 is performed, the elongation amount of the uncoated portions 12a is substantially constant regardless of the conveyance speed of the electrode sheet 10.

The graph in FIG. 6 shows that while the conveyance speed of the electrode sheet 10 is low, the gradient of increase in pressing force of the cylinder driving device 73 with respect to an increase in conveyance speed of the electrode sheet 10 is large. As the conveyance speed of the electrode sheet 10 increases, the gradient of increase in pressing force of the cylinder driving device 73 with respect to an increase in conveyance speed of the electrode sheet 10 decreases.

The pressure controller 103 controls the pressing force of the cylinder driving device 73 based on the acquired conveyance speed of the electrode sheet 10 and the relationship stored in the pressure memory 102. In this preferred embodiment, the pressure controller 103 applies a voltage corresponding to a pressing force of the cylinder driving device 73 to be applied, to the electropneumatic regulator 73a.

### <Press Control>

Operation in pressing the uncoated portions 12a of the electrode sheet 10 by the roll pressing machine 60 will now be described.

First, the controller 100 (see FIG. 3) controls the cylinder driving device 73 and the roll driving device 80. The cylinder driving device 73 moves the rod 71a of the press cylinders 71 downward. The cylinder driving device 73 moves the rod 71a downward to a predetermined position. Accordingly, the pressing rolls 62 move downward. At this time, the roll driving device 80 rotates the support roll 61. In this preferred embodiment, as illustrated in FIG. 5, the roll driving device 80 rotates the support roll 61 in the direction of arrow R1. When the pressing rolls 62 move downward, portions of the uncoated portions 12a sandwiched between the support roll 61 and the pressing rolls 62 are compressed.

The controller 100 controls the conveyor 15 to convey the electrode sheet 10 at a predetermined speed. However, in acceleration at start of conveyance of the electrode sheet 10 by the conveyor 15, the conveyance speed of the electrode sheet 10 is lower than a predetermined conveyance speed. The conveyance speed of the electrode sheet 10 gradually increases to approach the predetermined conveyance speed. Thus, at start of conveyance of the electrode sheet 10 by the conveyor 15, the pressure controller 103 reduces the pressing force of the cylinder driving device 73 as compared to when the conveyance speed of the electrode sheet 10 reaches the predetermined speed. In acceleration at start of conveyance of the electrode sheet 10 by the conveyor 15, the pressure controller 103 gradually increases the pressing force of the cylinder driving device 73. This control makes it possible to suppress an increase in the elongation amount of the uncoated portions 12a at start of roll press, as compared to during constant-speed conveyance. It is also possible to suppress a change of the elongation amount of the uncoated portions 12a during acceleration of the electrode sheet 10 (i.e., as the conveyance speed increases, the elongation amount decreases). Consequently, as shown in the graph G2 of FIG. 7, the elongation amount of the uncoated portions 12a can be made substantially constant regardless of the conveyance speed of the electrode sheet 10.

At the end of roll press step S6, the electrode sheet 10 may be pressed while being decelerated. In this case, the pressure controller 103 reduces the pressing force of the cylinder driving device 73 as compared to while the conveyance speed of the electrode sheet 10 is at the predetermined speed in deceleration at the end of conveyance of the electrode sheet 10. The pressure controller 103 gradually decreases the pressing force of the cylinder driving device 73 in deceleration at the end of conveyance of the electrode sheet 10. In addition, in the case of adjusting the conveyance speed (e.g., performing feedback control in accordance with other parameters) during conveyance of the electrode sheet 10, for example, the pressure controller 103 controls the pressing force of the cylinder driving device 73 to a pressing force corresponding to the controlled conveyance speed.

### Advantages of Preferred Embodiment

Advantages of the electrode sheet manufacturing device 1 according to this preferred embodiment will be described below.

The electrode sheet manufacturing device 1 according to the this preferred embodiment is a manufacturing device for manufacturing the electrode sheet 100 including the current collector 12 of long metal foil, the uncoated portion 12a defined along the length direction at a predetermined position in the width direction in the current collector 12, and the electrode active material layer 14 located in a portion of the current collector 12 except for the uncoated portion 12a, and includes: the conveyor 15 that conveys the electrode sheet 10 along the predetermined conveyance path 18; the support roll 61 that is located on the conveyance path 18, extends in the width direction of the electrode sheet 10, and supports the lower surface 10D of the electrode sheet 100 conveyed along the conveyance path 18; the pressing roll 62 including the rubber portion 62ab at the surface thereof, located toward the upper surface 10U of the electrode sheet 10 to face the support roll 61, and extending in the width direction of the electrode sheet 10; the cylinder driving device 73 that drives at least one of the support roll 61 and the pressing rolls 62 such that the pressing rolls 62 are pressed against the support roll 61; and the controller 100. The pressing rolls 62 sandwich the uncoated portion 12a together with the support roll 61 except for the electrode active material layer 14 of the electrode sheet 10. The controller 100 includes the pressure memory 102 that stores the predetermined relationship between the conveyance speed of the electrode sheet 10 by the conveyor 15 and the pressing force of the cylinder driving device 73, and the pressure controller 103 that controls the pressing force of the cylinder driving device 73 based on the conveyance speed of the electrode sheet 10 and the relationship stored in the pressure memory 102.

In the electrode sheet manufacturing device 1, the pressing force of the cylinder driving device 73 is controlled based on the predetermined relationship between the conveyance speed of the electrode sheet 10 and the pressing force of pressing the uncoated portions 12a so that even with a change of the conveyance speed of the electrode sheet 10, a change of the elongation amount of the uncoated portion 12a can be suppressed. As a result, crease of the uncoated portion 12a and breakage of the electrode sheet 10 can be reduced. The reason for the change of the elongation amount of the uncoated portion 12a caused by a change of the conveyance speed of the electrode sheet 10 is because the elastic deformation time of the rubber portion 62ab of the pressing roll 62 changes with a change of the conveyance speed. This phenomenon is unique to the technique of pressing a sheet with rubber rolls to roll the sheet.

In this preferred embodiment, in the relationship stored in the pressure memory 102, as the conveyance speed of the electrode sheet 10 increases, the pressing force of the cylinder driving device 73 is increased. According to findings of the inventors of the present invention, as the conveyance speed of the electrode sheet 10 increases, the elastic deformation time of the rubber portion 62ab of the pressing roll 62 decreases. Thus, with the same pressing force, the elongation amount of the uncoated portion 12a is small. Accordingly, the pressing force of the cylinder driving device 73 is controlled based on the relationship in which as the conveyance speed of the electrode sheet 10 increases, the pressing force of the cylinder driving device 73 is increased to thereby enable suppression of a change of the elongation amount of the uncoated portion 12a.

In this preferred embodiment, in acceleration at start of conveyance of the electrode sheet 10 by the conveyor 15, the pressure controller 103 gradually increases the pressing force of the cylinder driving device 73. In acceleration at start of conveyance of the electrode sheet 10, the conveyance speed of the electrode sheet 10 gradually increases. Thus, control of gradually increasing the pressing force of the cylinder driving device 73 can suppress a change of the elongation amount of the uncoated portions 12a in acceleration.

In this preferred embodiment, at start of conveyance of the electrode sheet 10 by the conveyor 15, the pressure controller 103 reduces the pressing force of the cylinder driving device 73 as compared to when the conveyance speed of the electrode sheet 10 reaches a predetermined speed. In acceleration at start of conveyance of the electrode sheet 10, the conveyance speed of the electrode sheet 10 is lower than that in constant-speed conveyance after the end of acceleration. Thus, control of reducing the pressing force of the cylinder driving device 73 in acceleration as compared to during constant-speed conveyance can reduce a difference in elongation amount of the uncoated portion 12a between acceleration and constant-speed conveyance.

The preferred embodiment of the present invention disclosed here has been described variously. The present invention is not limited to the embodiment described here unless otherwise specified. The preferred embodiment disclosed here can be modified in various ways. The constituent elements and the processes described here can be appropriately omitted or appropriately combined unless no particular problems arise.

For example, in the preferred embodiment described above, the first surface of the electrode sheet 10 supported by the support roll 61 is the lower surface 10D of the electrode sheet 10. Alternatively, the first surface of the electrode sheet 10 supported by the support roll 61 does not need to face downward. The support roll 61 may support the first surface of the electrode sheet 10 facing in another direction. Similarly, the second surface of the electrode sheet 10 is not limited to the upper surface 10U. The conveyance direction of the electrode sheet 10 by the conveyor 15 is not limited to the horizontal direction, and may be bent at some point.

For example, in the preferred embodiment described above, the support roll 61 includes the rubber portion 61ab. However, the rubber layer only needs to be included in at least the pressing rolls 62, and the support roll 61 may not include the rubber portion 61ab.

As described above, the specification includes the disclosures described in the following items.

### Item 1:

An electrode sheet manufacturing device for manufacturing an electrode sheet including a current collector of long metal foil, a non-formed portion defined along a length direction at a predetermined position in a width direction in the current collector, and an active material layer located in a portion of the current collector except for the non-formed portion, the electrode sheet manufacturing device comprising:
a conveyor that conveys the electrode sheet along a predetermined conveyance path;
a support roll that is located on the conveyance path, extends in a width direction of the electrode sheet, and supports a first surface of the electrode sheet conveyed along the conveyance path;
a pressing roll including a rubber layer at a surface thereof, located toward a second surface of the electrode sheet to face the support roll, and extending in the width direction of the electrode sheet;
a driver that drives at least one of the support roll and the pressing roll such that the pressing roll is pressed against the support roll; and
a controller, wherein
the pressing roll sandwiches the non-formed portion together with the support roll except for the active material layer of the electrode sheet, and
the controller includes
   a memory that stores a predetermined relationship between a conveyance speed of the electrode sheet by the conveyor and a pressing force of the driver, and
   a pressure controller that controls the pressing force of the driver based on the conveyance speed of the electrode sheet and the relationship stored in the memory.

### Item 2:

The electrode sheet manufacturing device according to Item 1, wherein
in the relationship stored in the memory, as the conveyance speed of the electrode sheet increases, the pressing force of the driver is increased.

### Item 3:

The electrode sheet manufacturing device according to Item 2, wherein
in acceleration at start of conveyance of the electrode sheet by the conveyor, the pressure controller gradually increases the pressing force of the driver.

### Item 4:

The electrode sheet manufacturing device according to Item 2 or 3, wherein
at start of conveyance of the electrode sheet by the conveyor, the pressure controller reduces the pressing force of the driver as compared to when the conveyance speed of the electrode sheet reaches a predetermined speed.

What is claimed is:

1. An electrode sheet manufacturing device for manufacturing an electrode sheet including a current collector of long metal foil, a non-formed portion defined along a length direction at a predetermined position in a width direction in the current collector, and an active material layer located in a portion of the current collector except for the non-formed portion, the electrode sheet manufacturing device comprising:
a conveyor that conveys the electrode along a predetermined conveyance path;
a support roll that is located on the conveyance path, extends in a width direction of the electrode sheet, and supports a first surface of the electrode sheet conveyed along the conveyance path;
a pressing roll including a rubber layer at a surface thereof, located toward a second surface of the electrode sheet to face the support roll, and extending in the width direction of the electrode sheet;
a driver that drives at least one of the support roll and the pressing roll such that the pressing roll is pressed against the support roll; and
a controller, wherein
the pressing roll sandwiches the non-formed portion together with the support roll except for the active material layer of the electrode sheet, and
the controller includes
a memory that stores a predetermined relationship between a conveyance speed of the electrode sheet by the conveyor and a pressing force of the driver, and
a pressure controller that controls the pressing force of the driver based on the conveyance speed of the electrode sheet and the relationship stored in the memory.

2. The electrode sheet manufacturing device according to claim 1, wherein
in the relationship stored in the memory, as the conveyance speed of the electrode sheet increases, the pressing force of the driver is increased.

3. The electrode sheet manufacturing device according to claim 2, wherein
in acceleration at start of conveyance of the electrode sheet by the conveyor, the pressure controller gradually increases the pressing force of the driver.

4. The electrode sheet manufacturing device according to claim 2, wherein
at start of conveyance of the electrode sheet by the conveyor, the pressure controller reduces the pressing force of the driver as compared to when the conveyance speed of the electrode sheet reaches a predetermined speed.
